(19) United States
(12) Patent Application Publication
(10) Pub. No.: US 2026/0084514 A1
(43) Pub. Date: Mar. 26, 2026

(54) MULTI-POSITION VARIABLE SPEED TRANSMISSION SYSTEM FOR HYBRID ELECTRIC VEHICLE

(71) Applicant: XIAMEN NEVC ADVANCED ELECTRIC POWERTRAIN TECHNOLOGY INNOVATION CENTER, Xiamen, Fujian (CN)

(72) Inventors: Jie XING, Xiamen (CN); Zhihui DUAN, Xiamen (CN); Shangdong YANG, Xiamen (CN); Lianghui YANG, Xiamen (CN); Jing LIN, Xiamen (CN); Shuiping LIN, Xiamen (CN); Yutao CHEN, Xiamen (CN)

(21) Appl. No.: 19/109,621

(22) PCT Filed: Jul. 26, 2023
(86) PCT No.: PCT/CN2023/109223

§ 371 Date: Mar. 7, 2025

(30) Foreign Application Priority Data
Sep. 8, 2022 (CN) 202211105655.6

(51) Int. Cl. B60K 6/547; B60K 6/36; B60K 6/442

(52) U.S. Cl. CPC B60K 6/547; B60K 6/36; B60K 6/442

(57) ABSTRACT

A multi-position variable speed transmission system for a hybrid electric vehicle includes an engine, a first motor, a second motor, an input shaft, an output shaft, a first intermediate shaft, a second intermediate shaft, and first, second and third synchronizers. The input shaft is connected to the engine. The intermediate shafts are respectively connected to the first and second motors. The input shaft is connected to the first synchronizer. The output shaft is connected to the second and third synchronizers. The first intermediate shaft is connected with a first transmission gear. The second intermediate shaft is connected with second transmission gears. The first or second transmission gear respectively meshes with one of gears on the output shaft.

### CROSS-REFERENCE TO RELATED APPLICATIONS

The present disclosure is a national phase entry of International Patent Application No. PCT/CN2023/109223, filed on Jul. 26, 2023, which claims priority to Chinese Patent Application No. 202211105655.6, filed on Sep. 8, 2022. International Patent Application No. PCT/CN2023/109223 and Chinese Patent Application No. 202211105655.6 are incorporated herein by reference.

### TECHNICAL FIELD

The invention relates to the technical field of hybrid electric vehicle manufacturing, and in particular to a multi-position variable speed transmission system for a hybrid electric vehicle.

### BACKGROUND

Hybrids are one of the important ways to save energy and reduce emissions for automobiles. Series-parallel hybrids are widely used in automobile enterprises in China due to their simple structure and low technical difficulty. The series-parallel hybrids have the advantage that the engine is completely decoupled from the wheels such that the engine can work under the optimum condition. The series-parallel hybrids have the following disadvantages: the torque/mechanical power outputted by the engine is subjected to energy conversion several times, which makes the torque transmission efficiency lower; and when the vehicle runs at a low speed, the series hybrid is adopted, and the torque of the engine cannot be involved in vehicle acceleration, which limits the vehicle acceleration. In addition, in the existing common hybrid variable speed transmission system, the engine usually has only one position in a parallel hybrid mode, and the drive motor also has only one position in an electric vehicle mode. The engine and the motor often work in low efficiency areas, which affects the fuel consumption of the whole vehicle. Moreover, there is a high requirement for the torque and speed range of the motor, which increases the cost of the drive motor and the use cost.

In order to overcome the disadvantages in the series-parallel hybrid variable speed transmission system, people have started to develop multi-position series-parallel hybrid systems to improve the engine operating point, enhance the engine efficiency and improve the acceleration performance of the whole vehicle.

Chinese Application No. 201910956880.2, filed on Jan. 10, 2020, discloses a special-purpose variable speed transmission system for a hybrid electric vehicle, which includes an engine (1), a first motor (3), a second motor (4), a second motor transmission assembly (5), a first clutch (6), a double-clutch assembly (7), a first position gear set (8), a second position gear set (9), a third position gear set (10), a synchronizer (11), a first input shaft (13) and a second input shaft (14). The engine (1) is connected to the first clutch (6). The first clutch (6) is connected to the first motor (3) and the first input shaft (13) respectively. One end of the double-clutch assembly (7) is connected to the first input shaft (13), and the other end is connected to the second input shaft (14). The second motor (4) is connected to the third position gear set (10). By arranging three clutches and three positions, the requirements for the power source are lowered, and multiple operating modes can be realized, thereby realizing efficient operation. However, this variable speed transmission system, even with three clutches, still realizes a small number of positions, the fuel economy still needs to be improved, and the overall structure is complicated. In addition, most of the existing series-parallel hybrid variable speed transmission systems cannot realize gear shifting in an EV (electric vehicle) or HEV (hybrid electric vehicle) mode without power interruption, which reduces the running smoothness of the vehicle.

### SUMMARY

A technical problem to be solved by the invention is to provide a multi-position variable speed transmission system for a hybrid electric vehicle, which is compact in structure and low in use cost, can realize gear shifting without power interruption, improves the running smoothness of the vehicle and has a large number of shiftable gears.

In order to achieve the above objective, a technical solution of the invention is as follows: A multi-position variable speed transmission system for a hybrid electric vehicle includes an engine, a first motor, a second motor, an input shaft and an output shaft. The input shaft is connected to the engine. The variable speed transmission system further includes a first intermediate shaft, a second intermediate shaft, a first synchronizer, a second synchronizer and a third synchronizer. The first intermediate shaft is connected to the first motor, and the second intermediate shaft is connected to the second motor.

The first synchronizer is connected to the input shaft, a first gear and a second gear are sleeved on the input shaft, and the input shaft is connected or disconnected with the first gear or the second gear respectively through the first synchronizer.

Both the second synchronizer and the third synchronizer are connected to the output shaft, a third gear, a fourth gear, a fifth gear and a sixth gear are sleeved on the output shaft, the output shaft is connected or disconnected with the third gear or the fourth gear respectively through the second synchronizer, and the output shaft is connected or disconnected with the fifth gear or the sixth gear respectively through the third synchronizer.

The first intermediate shaft is connected with at least one first transmission gear which selectively meshes with one of the gears sleeved on the output shaft, or the output shaft is further connected with a third transmission gear, and the first transmission gear meshes with the third transmission gear.

The second intermediate shaft is connected with a plurality of second transmission gears, and each of the second transmission gears connected with the second intermediate shaft selectively meshes with one of the gears sleeved on the output shaft.

The first gear or the second gear respectively meshes with one of the gears sleeved on the output shaft, and/or the first gear or the second gear respectively meshes with one of the second transmission gears on the second intermediate shaft.

Preferably, the first intermediate shaft is connected with two first transmission gears which are a seventh gear and an eighth gear respectively, the seventh gear meshes with the fifth gear, and the eighth gear meshes with the sixth gear. The second intermediate shaft is connected with two second transmission gears which are a ninth gear and a tenth gear respectively, the ninth gear meshes with the third gear, and the tenth gear meshes with the fourth gear. The first gear meshes with the third gear, and the second gear meshes with the fourth gear.

As a further improvement, the third gear is formed by connecting a third large gear and a third small gear, an outer diameter of the third large gear is greater than an outer diameter of the third small gear, the third large gear meshes with the first gear, and the third small gear meshes with the ninth gear. In this way, it is more convenient to design an appropriate speed ratio.

Preferably, the first intermediate shaft is connected with two first transmission gears which are a seventh gear and an eighth gear respectively, the seventh gear meshes with the fifth gear, and the eighth gear meshes with the sixth gear. The second intermediate shaft is connected with two second transmission gears which are a ninth gear and a tenth gear respectively, the ninth gear meshes with the third gear, and the tenth gear meshes with the fourth gear. The first gear meshes with the ninth gear, and the second gear meshes with the tenth gear. In this way, the first intermediate shaft and the second intermediate shaft are located between the input shaft and the output shaft, which facilitates the arrangement of the positions of the input shaft and the output shaft and provides another solution for gear mounting.

Preferably, the first intermediate shaft is connected with two first transmission gears which are a seventh gear and an eighth gear respectively, the seventh gear meshes with the fifth gear, and the eighth gear meshes with the sixth gear. The second intermediate shaft is connected with two second transmission gears which are a ninth gear and a tenth gear respectively, the ninth gear meshes with the third gear, and the tenth gear meshes with the fourth gear. The first gear meshes with the fourth gear, and the second gear meshes with the fifth gear.

Preferably, the first intermediate shaft is connected with one first transmission gear which is a twelfth gear, the output shaft is further connected with a third transmission gear which is a thirteenth gear, and the twelfth gear meshes with the thirteenth gear.

The second intermediate shaft is connected with four second transmission gears which are a seventh gear, an eighth gear, a ninth gear and a tenth gear respectively, the seventh gear meshes with the third gear, the eighth gear meshes with the fourth gear, the ninth gear meshes with the fifth gear, and the tenth gear meshes with the sixth gear. The first gear meshes with the third gear, and the second gear meshes with the fourth gear. With this structure, the first motor can drive the output shaft without a synchronizer.

As a further improvement, the sixth gear is directly connected to the output shaft, the sixth gear becomes the third transmission gear, and the third synchronizer only connects or disconnects the fifth gear with the output shaft. The first intermediate shaft is connected with one first transmission gear which is a tenth gear, and the tenth gear meshes with the sixth gear. The second intermediate shaft is connected with three second transmission gears which are a seventh gear, an eighth gear and a ninth gear respectively, the seventh gear meshes with the third gear, the eighth gear meshes with the fourth gear, and the ninth gear meshes with the fifth gear. The first gear meshes with the third gear, and the second gear meshes with the fourth gear. With this structure, the first motor can drive the output shaft without a synchronizer.

As a variation, the first synchronizer, the second synchronizer and the third synchronizer are replaced by clutches. Further, the clutches may be dog clutches.

Preferably, the variable speed transmission system has any one or more of the following operating modes:
electric vehicle mode: the first motor and/or the second motor are involved in driving the output shaft;
series hybrid mode: the engine is involved in driving the output shaft, or the engine and the first motor are involved in driving the output shaft, and the second motor is involved in power generation; and
parallel hybrid mode: the engine is involved in driving the output shaft, the second motor is involved in synchronization during gear shifting, and the first motor is involved in driving the output shaft during gear shifting.

In order to achieve the above objective, another technical solution of the invention is as follows: A multi-position variable speed transmission system for a hybrid electric vehicle includes an engine, a first motor, a second motor, an input shaft and an output shaft. The input shaft is connected to the engine. The variable speed transmission system further includes a first intermediate shaft, a second intermediate shaft, a first synchronizer, a second synchronizer and a third synchronizer. The first intermediate shaft is connected to the first motor, and the second intermediate shaft is connected to the second motor.

Both the first synchronizer and the second synchronizer are connected to the input shaft, a first gear, a second gear, a third gear and a fourth gear are sleeved on the input shaft, the input shaft is connected or disconnected with the first gear or the second gear respectively through the first synchronizer, and the input shaft is connected or disconnected with the third gear or the fourth gear respectively through the second synchronizer.

The third synchronizer is connected to the output shaft, a fifth gear and a sixth gear are sleeved on the output shaft, the output shaft is connected or disconnected with the fifth gear or the sixth gear respectively through the third synchronizer.

The first intermediate shaft is connected with two first transmission gears which are a seventh gear and an eighth gear respectively, the seventh gear meshes with the third gear, and the eighth gear meshes with the fourth gear.

The second intermediate shaft is connected with two second transmission gears which are a ninth gear and a tenth gear respectively, the ninth gear meshes with the first gear, and the tenth gear meshes with the second gear.

The first gear meshes with the fifth gear, and the second gear meshes with the sixth gear.

In order to achieve the above objective, still another technical solution of the invention is as follows: A multi-position variable speed transmission system for a hybrid electric vehicle includes an engine, a first motor, a second motor, an input shaft and an output shaft. The input shaft is connected to the engine. The variable speed transmission system further includes a first intermediate shaft, a second intermediate shaft, a first synchronizer, a second synchronizer and a third synchronizer. The first intermediate shaft is connected to the first motor, and the second intermediate shaft is connected to the second motor.

The first synchronizer is connected to the input shaft, a first gear and a second gear are sleeved on the input shaft, the input shaft is connected or disconnected with the first gear or the second gear respectively through the first synchronizer, and the input shaft is further connected with a third gear.

The second synchronizer is connected to the output shaft, a fourth gear and a fifth gear are sleeved on the output shaft, the output shaft is connected or disconnected with the fourth gear or the fifth gear respectively through the second synchronizer, and the output shaft is further connected with a sixth gear.

The third synchronizer is connected to the first intermediate shaft, a seventh gear and an eighth gear are sleeved on the first intermediate shaft, and the first intermediate shaft is connected or disconnected with the seventh gear or the eighth gear respectively through the third synchronizer.

The second intermediate shaft is connected with a ninth gear and a tenth gear, the ninth gear meshes with the fourth gear, the tenth gear meshes with the fifth gear, the first gear meshes with the fifth gear, and the second gear meshes with the fourth gear.

The third gear meshes with the seventh gear, and the sixth gear meshes with the eighth gear.

In order to achieve the above objective, still another technical solution of the invention is as follows: A multi-position variable speed transmission system for a hybrid electric vehicle includes an engine, a first motor, a second motor, an input shaft and an output shaft. The input shaft is connected to the engine. The variable speed transmission system further includes a first intermediate shaft, a second intermediate shaft, a first synchronizer, a second synchronizer and a third synchronizer. The first intermediate shaft is connected to the first motor, and the second intermediate shaft is connected to the second motor.

The first synchronizer is connected to the input shaft, a first gear and a second gear are sleeved on the input shaft, and the input shaft is connected or disconnected with the first gear or the second gear respectively through the first synchronizer.

The second synchronizer is connected to the output shaft, a third gear and a fourth gear are sleeved on the output shaft, the output shaft is connected or disconnected with the third gear or the fourth gear respectively through the second synchronizer, and the output shaft is further connected with a fifth gear.

The third synchronizer is connected to the first intermediate shaft and corresponds to one end of the input shaft, a sixth gear is sleeved on the first intermediate shaft, the first intermediate shaft is connected or disconnected with the sixth gear through the third synchronizer, and the first intermediate shaft is further connected or disconnected with the input shaft through the third synchronizer.

The second intermediate shaft is connected with a seventh gear and an eighth gear, the seventh gear meshes with the third gear, and the eighth gear meshes with the fourth gear. The first gear meshes with the fourth gear, the second gear meshes with the third gear, and the fifth gear meshes with the sixth gear.

The invention has the following beneficial effects:
1. Gear shifting without power interruption can be realized in both EV and HEV modes, which effectively improves the running smoothness of the vehicle. In the EV mode, both of the motors can drive, so there is no power interruption during gear shifting, thus making the gear shifting smooth. In the HEV mode, the engine and the motor drive alternately, so there is no power interruption during gear shifting, thus making the gear shifting smooth. By controlling the engine, the first motor, the second motor and the gear shifting mechanisms, the vehicle can switch between the EV, parallel hybrid and series hybrid modes smoothly, thereby effectively improving the running smoothness of the vehicle.
2. When the variable speed transmission system is in the EV mode, both of the two motors can drive at the same time, so the torques of the motors can be reduced by one third to one half, thus greatly reducing the weight, size and cost.
3. According to the variable speed transmission system, the second motor can realize multiple functions. First, the second motor can drive the output shaft to realize EV output. Second, the second motor can serve as a start motor so as to be involved in starting the engine. Third, after the engine is started, the second motor can serve as a generator to charge the power battery. Fourth, the second motor can be involved in synchronization, which facilitates the combination of the first synchronizer with the first gear or the second gear and the combination of the second synchronizer with the third gear or the fourth gear. Thus, the second motor can realize multiple functions, thereby reducing the components arranged and making the overall structure more compact.
4. The variable speed transmission system can realize various required modes on the premise of requiring fewer components and lower manufacturing cost. Moreover, the system requires fewer control elements, which can make the control simpler, improve the system reliability and lower the cost.
5. The variable speed transmission system can realize multiple modes and positions, improve the fuel economy and reduce the energy loss of the power supply, thus having a lower use cost. Specifically, the engine can have 4 positions and 8 mode combinations in the parallel hybrid mode, 4 positions and 8 mode combinations in the EV mode, and 4 positions and 4 mode combinations in the series hybrid mode.

### BRIEF DESCRIPTION OF DRAWINGS

FIG. 1 is a schematic structural diagram of Embodiment I of the invention;

FIG. 2 is a schematic structural diagram of Embodiment II of the invention;

FIG. 3 is a schematic structural diagram of Embodiment III of the invention;

FIG. 4 is a schematic structural diagram of Embodiment IV of the invention;

FIG. 5 is a schematic structural diagram of Embodiment V of the invention;

FIG. 6 is a schematic structural diagram of Embodiment VI of the invention;

FIG. 7 is a schematic structural diagram of Embodiment VII of the invention;

FIG. 8 is a schematic structural diagram of Embodiment VIII of the invention; and

FIG. 9 is a schematic structural diagram of Embodiment IX of the invention.

### DESCRIPTION OF EMBODIMENTS

The invention will be further described in detail below in conjunction with the accompanying drawings and specific implementations.

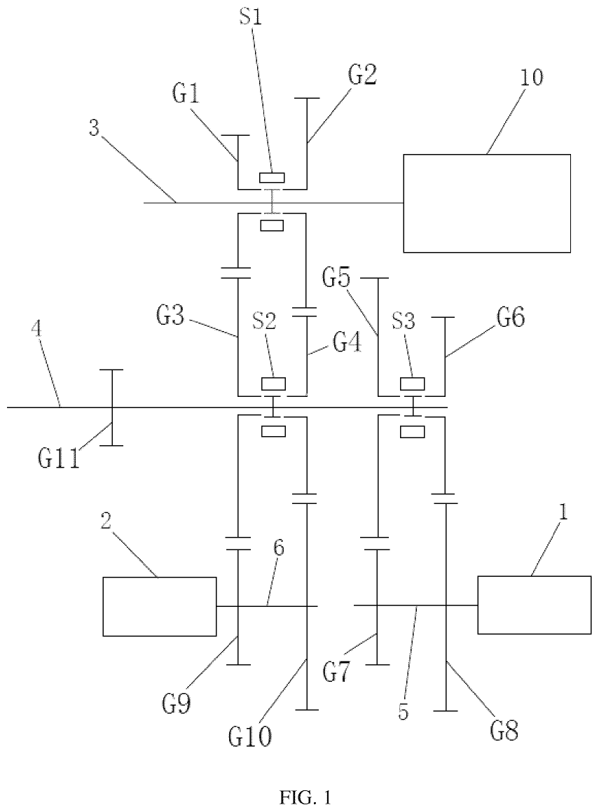

Embodiment I: As shown in FIG. 1, a multi-position variable speed transmission system for a hybrid electric vehicle includes an engine 10, a first motor 1, a second motor 2, an input shaft 3, an output shaft 4, a first intermediate shaft 5, a second intermediate shaft 6, a first synchronizer S1, a second synchronizer S2 and a third synchronizer S3. The input shaft 3 is connected to the engine 10. The first intermediate shaft 5 is connected to the first motor 1. The second intermediate shaft 6 is connected to the second motor 2. A drive shaft of the first motor 1 may be connected to the first intermediate shaft 5 or integrated with the first intermediate shaft 5 through a coupling. A drive shaft of the second motor 2 may be connected to the second intermediate shaft 6 or integrated with the second intermediate shaft 6 through a coupling. The first intermediate shaft 5 and the second intermediate shaft 6 are parallel to the input shaft 3 and the output shaft 4.

The first synchronizer S1 is connected to the input shaft 3, a first gear G1 and a second gear G2 are sleeved on the input shaft 3, and the input shaft 3 is connected or disconnected with the first gear G1 or the second gear G2 respectively through the first synchronizer S1.

Both the second synchronizer S2 and the third synchronizer S3 are connected to the output shaft 4, a third gear G3, a fourth gear G4, a fifth gear G5 and a sixth gear G6 are sleeved on the output shaft 4, the output shaft 4 is connected or disconnected with the third gear G3 or the fourth gear G4 respectively through the second synchronizer S2, and the output shaft 4 is connected or disconnected with the fifth gear G5 or the sixth gear G6 respectively through the third synchronizer S3.

The first intermediate shaft 5 is connected with two first transmission gears which are a seventh gear G7 and an eighth gear G8 respectively, the seventh gear G7 meshes with the fifth gear G5, and the eighth gear G8 meshes with the sixth gear G6.

The second intermediate shaft 6 is connected with two second transmission gears which are a ninth gear G9 and a tenth gear G10 respectively, the ninth gear G9 meshes with the third gear G3, and the tenth gear G10 meshes with the fourth gear G4. The first gear G1 meshes with the third gear G3, and the second gear G2 meshes with the fourth gear G4. The output shaft 4 is further connected with an output gear G11.

In this embodiment, the first synchronizer S1, the second synchronizer S2 and the third synchronizer S3 may be replaced by clutches. The clutches may be dog clutches.

In this embodiment, the variable speed transmission system has any one or more of the following operating modes:
electric vehicle mode: the first motor 1 and/or the second motor 2 are involved in driving the output shaft 4;
series hybrid mode: the engine 10 is involved in driving the output shaft 4, or the engine 10 and the first motor 1 are involved in driving the output shaft 4, and the second motor 2 is involved in power generation; and
parallel hybrid mode: the engine 10 is involved in driving the output shaft 4, the second motor 2 is involved in synchronization during gear shifting, and the first motor 1 is involved in driving the output shaft 4 during gear shifting.

In this embodiment, two power trains are formed. Power train 1: The first gear G1 and the second gear G2 sleeved on the input shaft 3 may be connected through the first synchronizer S1 and respectively mesh with the third gear G3 and the fourth gear G4 connected to the output shaft 4 through the second synchronizer S2, and the third gear G3 and the fourth gear G4 respectively mesh with the ninth gear G9 and the tenth gear G10 connected to the second intermediate shaft 6. Power train 2: The fifth gear G5 and the sixth gear G6 on the output shaft 4 may be connected through the third synchronizer S3 and respectively mesh with the seventh gear G7 and the eighth gear G8 connected to the first intermediate shaft 5. Alternatively, the third gear G3 and the fourth gear G4 on the output shaft 4 may be respectively connected through the second synchronizer S2 and respectively mesh with the ninth gear G9 and the tenth gear G10 connected to the second intermediate shaft 6.

This embodiment can realize gear shifting without power interruption in the electric vehicle (EV) mode:
When the vehicle runs in the EV mode, the first synchronizer S1 disengages, and the engine 10 is turned off. The first motor 1 outputs power to the output shaft 4 through the first intermediate shaft 5, the seventh gear G7, the fifth gear G5 and the third synchronizer S3, or the first motor 1 may output power to the output shaft 4 through the first intermediate shaft 5, the eighth gear G8, the sixth gear G6 and the third synchronizer S3. The second motor 2 may output power to the output shaft 4 through the second intermediate shaft 6, the ninth gear G9, the third gear G3 and the second synchronizer S2, or the second motor 2 may output power to the output shaft 4 through the second intermediate shaft 6, the tenth gear G10, the fourth gear G4 and the second synchronizer S2.

During gear shifting, the first motor 1 drives, and compensates, if necessary, for the driving force unloaded by the second motor 2, the second motor 2 unloads, the second synchronizer S2 may disengage and engage in another position of the second motor 2, the second motor 2 restores its driving force, and the first motor 1 reduces its driving force. Similarly, if the second motor 2 drives, the first motor 1 can complete gear shifting. During the gear shifting process, there is always one motor that outputs the driving force, so there is no power interruption.

In this embodiment, the working process of switching from the EV mode to the HEV series hybrid mode is as follows:

When in the EV mode, the engine 10 is turned off, the first synchronizer S1 disengages, the third synchronizer S3 engages the fifth gear G5 or the sixth gear G6, the first motor 1 drives the output shaft 4 through the first intermediate shaft 5, the seventh gear G7/fifth gear G5 or the eighth gear G8/sixth gear G6, and the third synchronizer S3. When the first motor 1 drives, the first synchronizer S1 engages the second gear G2, and the second motor 2 may start the engine and generate power through the second intermediate shaft 6, the tenth gear G10, the fourth gear G4, the second gear G2, the first synchronizer S1 and the input shaft 3; or the first synchronizer S1 engages the first gear G1, and the second motor 2 may start the engine and generate power through the second intermediate shaft 6, the ninth gear G9, the third gear G3, the first gear G1, the first synchronizer S1 and the input shaft 3.

In this embodiment, the working process of switching from the HEV series hybrid mode to the parallel hybrid mode is as follows:

Example 1: When in the series hybrid mode, the engine is connected to the second motor 2 through the input shaft 3, the first synchronizer S1 (engaging the first gear G1), the first gear G1/third gear G3/ninth gear G9 and the second intermediate shaft 6 to drive the second motor 2 to generate power, and the first motor 1 drives the output shaft 4 through the first intermediate shaft 5, the seventh gear G7/fifth gear G5 or the eighth gear G8/sixth gear G6 and the third synchronizer S3. When switching from the series hybrid mode to the parallel hybrid mode, the first motor 1 continues driving, so there is no power interruption for the vehicle; the second motor 2, which is connected to the engine 10, drives the engine 10 to adjust the speed, and when the output shaft 4 is synchronous with the third gear G3 or the fourth gear G4, the second synchronizer S2 engages the third gear G3 or the fourth gear G4 so as to connect the engine 10 to the output shaft 4; and then, the engine 10 restores the output torque, and drives the output shaft 4 through the input shaft 3, the first synchronizer S1, the first gear G1/third gear G3 and the second synchronizer S2 (engaging the third gear G3). The system enters the HEV parallel hybrid mode.

Example 2: When in the series hybrid mode, the engine 10 is connected to the second motor 2 through the input shaft 3, the first synchronizer S1 (engaging the first gear G1), the first gear G1/third gear G3, the tenth gear G10 and the second intermediate shaft 6 to drive the second motor 2 to generate power, and the first motor 1 drives the output shaft 4 through the first intermediate shaft 5, the seventh gear G7/fifth gear G5 or the eighth gear G8/sixth gear G6 and the third synchronizer S3. When switching from the series hybrid mode to the parallel hybrid mode, the engine 10 and the second motor 2 unload, the first motor 1 drives the output shaft 4, and the first synchronizer S1 disengages the first gear G1. In this case, there are two methods for the first synchronizer S1 to adjust the speed and shift gears: Method 1: The engine 10 adjusts the speed, and when the input shaft 3 is synchronous with the second gear G2, the first synchronizer S1 engages the second gear G2. Method 2: the second motor 2 adjusts the speed, and when the second gear G2 is synchronous with the input shaft 3, the first synchronizer S1 engages the second gear G2; after the first synchronizer S1 completes speed adjustment and gear shifting, the second motor 2 adjusts the speed to drive the engine 10 to adjust the speed, and when the third gear G3 or the fourth gear G4 is synchronous with the output shaft 4, the second synchronizer S2 engages the third gear G3 or the fourth gear G4 so as to connect the engine 10 to the output shaft 4. The engine 10 drives the output shaft 4 through the input shaft 3, the first synchronizer S1, the second gear G2/fourth gear G4 and the second synchronizer S2 (engaging the fourth gear G4). The system enters the HEV parallel hybrid mode.

This embodiment can also realize gear shifting without power interruption in the HEV mode:

The first synchronizer S1 engages the first gear G1, the second synchronizer S2 engages the third gear G3, the engine 10 drives the output shaft 4 through the input shaft 3, the first synchronizer S1, the first gear G1/third gear G3 and the second synchronizer S2, the second motor 2 drives the output shaft 4 through the second intermediate shaft 6, the ninth gear G9/third gear G3 and the second synchronizer S2, and the first motor 1 may drive the output shaft 4 through the first intermediate shaft 5, the seventh gear G7/fifth gear G5 or the eighth gear G8/sixth gear G6 and the third synchronizer S3 (engaging the fifth gear G5 or the sixth gear G6). At this time, to shift from the third gear G3 to the fourth gear G4, the operation is as follows: the engine 10 and the second motor 2 unload, the first motor 1 drives the output shaft 4 and compensates for the torques of the engine 10 and the second motor 2, and the second synchronizer S2 disengages the third gear G3; and the second motor 2 adjusts the speed, and when the fourth gear G4 is synchronous with the output shaft 4, the second synchronizer S2 engages the fourth gear G4, the first motor 1 reduces the torque, and the engine 10 and the second motor 2 restore the torques to drive the output shaft 4, thereby completing gear shifting without power interruption. At this time, to shift from the first gear G1 to the second gear G2, the operation is as follows: the engine 10 and the second motor 2 unload, the first motor 1 drives the output shaft 4 and compensate for the torques of the engine 10 and the second motor 2, the first synchronizer S1 disengages the first gear G1, and the second synchronizer S2 disengages the third gear G3; the second motor 2 adjusts the speed, and when the second gear G2 is synchronous with the input shaft 3, the first synchronizer S1 engages the second gear G2; and the second motor 2 adjusts the speed, and when the third gear G3 is synchronous with the output shaft 4, the second synchronizer S2 engages the third gear G3 again, the first motor 1 reduces the torque, the engine 10 and the second motor 2 restore the torques to drive the output shaft 4, thereby completing gear shifting without power interruption. The operations for the other two positions are similar.

This embodiment can also realize gear shifting without power interruption under the series hybrid mode:

When in the series hybrid mode, the engine 10 and the motor connected to the engine 10 unload, and the first synchronizer S1 disengages, so that the system enters the EV mode. In this case, gear shifting without power interruption can be realized according to the above description for the EV mode. After the gear shifting is completed, the system can enter the new series hybrid mode according to the description for switching from the EV mode to the HEV series hybrid mode, thereby completing gear shifting without power interruption in the series hybrid mode.

This embodiment can realize charging while driving and charging while parking in the series hybrid mode. When in the series hybrid mode, the motor functions to drive does not output the torque or both the second synchronizer S2 and the third synchronizer S3 are put into neutral.

In this embodiment, the positions may be set as follows:

| | | | | First | Second | Third |
|---|---|---|---|---|---|---|
| | Engine | | | synchronizer | synchronizer | synchronizer |
| | 10 | First motor 1 | Second motor 2 | S1 | S2 | S3 |
| EV 1st position | Off | Drive/regenerative brake | Off | Neutral | Neutral | Left |
| EV 2nd position | Off | Drive/regenerative brake | Off | Neutral | Neutral | Right |
| EV 3rd position | Off | Off | Drive/regenerative brake | Neutral | Left | Neutral |
| EV 4th position | Off | Off | Drive/regenerative brake | Neutral | Right | Neutral |
| Parallel hybrid | On | Off | Drive/regenerative brake | Left | Left | Neutral |
| 1st position | | | | | | |
| Parallel hybrid | On | Off | Drive/regenerative brake | Left | Right | Neutral |
| 2nd position | | | | | | |
| Parallel hybrid | On | Off | Drive/regenerative brake | Right | Right | Neutral |
| 3rd position | | | | | | |
| Parallel hybrid | On | Off | Drive/regenerative brake | Right | Left | Neutral |
| 4th position | | | | | | |
| Series hybrid | On | Drive/regenerative brake | Start engine/generate | Left or | Neutral | Left |
| 1st position | | | power | right | | |
| Series hybrid | On | Drive/regenerative brake | Start engine/generate | Left or | Neutral | Right |
| 2nd position | | | power | right | | |

Note:
The positions are shown in an example of single motor drive, and the positions are not affected in the case of double motor drive.

Modes: EV: 4 positions for single motor drive; and 4 combinations for double motor drive: in the table, the EV 1st position is combined with the EV 3rd or 4th position, and the EV 2nd position is combined with the EV 3rd or 4th position. There are a total of 8 modes.

Parallel hybrid: 4 positions for single motor parallel hybrid; and 8 combinations for double motor parallel hybrid: in the table, the parallel hybrid 1st position is combined with the EV 3rd or 4th position, the parallel hybrid 2nd position is combined with the EV 3rd or 4th position, the parallel hybrid 3rd position is combined with the EV 3rd or 4th position, and the parallel hybrid 4th position is combined with the EV 3rd or 4th position. There are a total of 12 modes.

Series hybrid: 2 positions for series hybrid, which correspond to 4 modes depending on whether the first synchronizer S1 engages the gear on the left side or the gear on the right side.

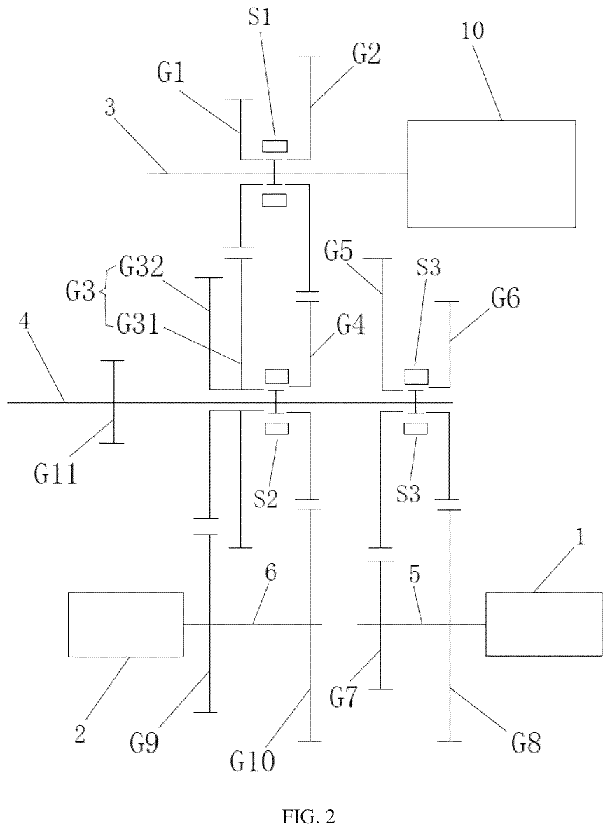

Embodiment II: As shown in FIG. 2, a multi-position variable speed transmission system for a hybrid electric vehicle, with reference to the description of Embodiment I, is different from Embodiment I in that: the third gear G3 is formed by connecting a third large gear G31 and a third small gear G32, an outer diameter of the third large gear G31 is greater than an outer diameter of the third small gear G32, the third large gear G31 meshes with the first gear G1, and the third small gear G32 meshes with the ninth gear G9. In this way, a wider speed ratio range can be obtained. Other working principles are basically the same as in Embodiment I.

The positions of this embodiment are set in the same way as Embodiment I.

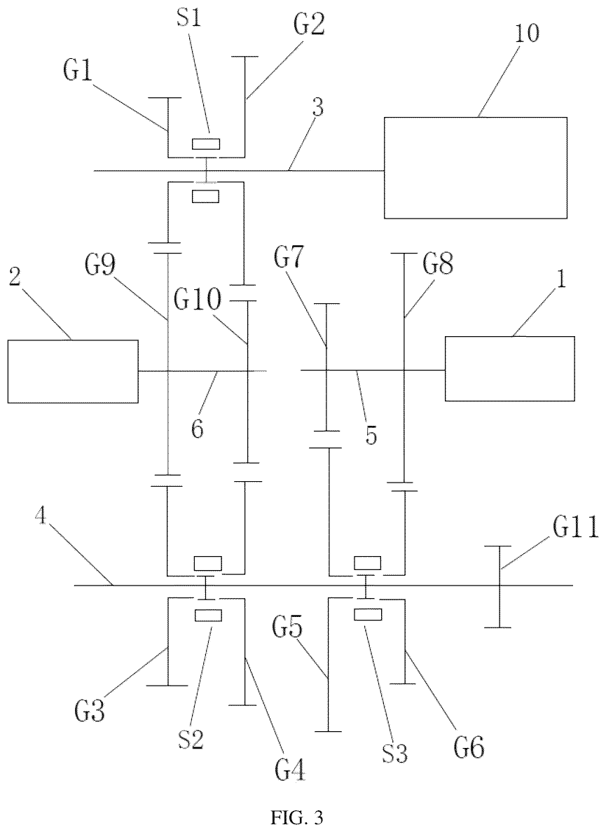

Embodiment III: As shown in FIG. 3, a multi-position variable speed transmission system for a hybrid electric vehicle, with reference to the description of Embodiment I, is different from Embodiment I in that: the first gear G1 meshes with the ninth gear G9, the first gear G1 does not directly mesh with the third gear G3, but transmits power through the ninth gear G9; and the second gear G2 meshes with the tenth gear G10, and the second gear G2 does not directly mesh with the fourth gear G4, but transmits power through the tenth gear G10. The working principles of this embodiment are basically the same as those in Embodiment I, except that: the first intermediate shaft 5 and the second intermediate shaft 6 are located between the input shaft 3 and the output shaft 4, and the engine 10 drives the output shaft 4 through the input shaft 3, the first synchronizer S1, the second gear G2/tenth gear G10/fourth gear G4 or the first gear G1/ninth gear G9/third gear G3, the second intermediate shaft 6 and the second synchronizer S2.

With reference to the detailed description of the above embodiments and FIG. 3, those skilled in the art can understand the specific working process of this embodiment, and details will not be repeated here.

In this embodiment, the positions may be set as follows:

| | | | | First | Second | Third |
|---|---|---|---|---|---|---|
| | Engine | | | synchronizer | synchronizer | synchronizer |
| | 10 | First motor 1 | Second motor 2 | S1 | S2 | S3 |
| EV 1st position | Off | Drive/regenerative brake | Off | Neutral | Neutral | Left |
| EV 2nd position | Off | Drive/regenerative brake | Off | Neutral | Neutral | Right |
| EV 3rd position | Off | Off | Drive/regenerative brake | Neutral | Left | Neutral |
| EV 4th position | Off | Off | Drive/regenerative brake | Neutral | Right | Neutral |
| Parallel hybrid | On | Off | Drive/regenerative brake | Left | Left | Neutral |
| 1st position | | | | | | |
| Parallel hybrid | On | Off | Drive/regenerative brake | Left | Right | Neutral |
| 2nd position | | | | | | |
| Parallel hybrid | On | Off | Drive/regenerative brake | Right | Right | Neutral |
| 3rd position | | | | | | |
| Parallel hybrid | On | Off | Drive/regenerative brake | Right | Left | Neutral |
| 4th position | | | | | | |
| Series hybrid | On | Drive/regenerative brake | Start engine/generate | Left or | Neutral | Left |
| 1st position | | | power | right | | |
| Series hybrid | On | Drive/regenerative brake | Start engine/generate | Left or | Neutral | Right |
| 2nd position | | | power | right | | |

Note:
The positions are shown in an example of single motor drive, and the positions are not affected in the case of double motor drive.

Modes: EV: 4 positions for single motor drive; and 4 combinations for double motor drive: in the table, the EV 1st position is combined with the EV 3rd or 4th position, and the EV 2nd position is combined with the EV 3rd or 4th position. There are a total of 8 modes.

Parallel hybrid: 4 positions for single motor parallel hybrid; and 8 combinations for double motor parallel hybrid: in the table, the parallel hybrid 1st position is combined with the EV 3rd or 4th position, the parallel hybrid 2nd position is combined with the EV 3rd or 4th position, the parallel hybrid 3rd position is combined with the EV 3rd or 4th position, and the parallel hybrid 4th position is combined with the EV 3rd or 4th position. There are a total of 12 modes.

Series hybrid: 2 positions for series hybrid, which correspond to 4 modes depending on whether the first synchronizer S1 engages the gear on the left side or the gear on the right side.

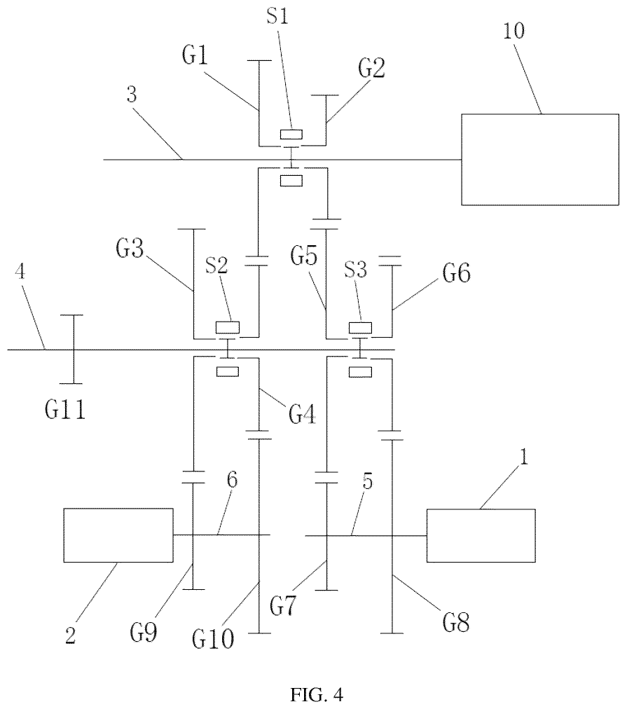

Embodiment IV: As shown in FIG. 4, a multi-position variable speed transmission system for a hybrid electric vehicle, with reference to the description of Embodiment I, is different from Embodiment I in that: the first gear G1 meshes with the fourth gear G4, and the second gear G2 meshes with the fifth gear G5.

The main working principles of this embodiment are as follows:

This embodiment can realize gear shifting without power interruption in the EV mode:

When the vehicle runs in the EV mode, the first synchronizer S1 disengages, and the engine 10 is turned off. The first motor 1 may output power to the output shaft 4 through the first intermediate shaft 5, the seventh gear G7/fifth gear G5 and the third synchronizer S3, or through the first intermediate shaft 5, the eighth gear G8/sixth gear G6 and the third synchronizer S3. The second motor 2 may output power to the output shaft 4 through the first intermediate shaft 5, the tenth gear G10/fourth gear G4 and the second synchronizer S2, or through the ninth gear G9/third gear G3 and the second synchronizer S2.

During gear shifting, the first motor 1 drives, and compensates, if necessary, for the driving force unloaded by the second motor 2, the second motor 2 unloads, the second synchronizer S2 may disengage and engage in another position of the second motor 2, the second motor 2 restores its driving force, and the first motor 1 reduces its driving force. Similarly, if the second motor 2 drives, the first motor 1 can complete gear shifting. During the gear shifting process, there is always one motor that outputs the driving force, so there is no power interruption.

In this embodiment, the working process of switching from the EV mode to the HEV series hybrid mode is as follows:

When in the EV mode, the engine 10 is turned off, the firs synchronizer S1 disengages, the third synchronizer S3 engages the fifth gear G5 or the sixth gear G6, the first motor 1 drives the output shaft 4 through the first intermediate shaft 5, the seventh gear G7/fifth gear G5 or the eighth gear/G8 sixth gear G6, and the third synchronizer S3. The first synchronizer S1 engages the first gear G1, the second synchronizer S2 disengages, and the second motor 2 drives and starts the engine 10 through the second intermediate shaft 6, the tenth gear G10/fourth gear G4/first gear G1, the first synchronizer S1 and the input shaft 3. Then, the engine 10 starts working to output power and drive the second motor 2 to generate power which is supplied to the first motor 1, the first motor 1 drives the vehicle, and the system enters the HEV series hybrid mode. According to the symmetry, the second motor 2 may also function to drive, and the first motor 1 starts the engine 10 and generates power.

In this embodiment, the working process of switching from the HEV series hybrid mode to the parallel hybrid mode is as follows:

Example 1: When in the series hybrid mode, the engine 10 is connected to the second motor 2 through the input shaft 3, the first synchronizer S1 (engaging the first gear G1), the first gear G1/fourth gear G4/tenth gear G10 and the second intermediate shaft 6 to drive the second motor 2 to generate power, and the first motor 1 drives the output shaft 4 through the first intermediate shaft 5, the seventh gear G7/fifth gear G5 or the eighth gear G8/sixth gear G6 and the third synchronizer S3. When switching from the series hybrid mode to the parallel hybrid mode, the first motor 1 continues driving, so there is no power interruption for the vehicle; the second motor 2, which is connected to the engine 10, drives the engine 10 to adjust the speed, and when the output shaft 4 is synchronous with the third gear G3 or the fourth gear G4, the second synchronizer S2 engages the third gear G3 or the fourth gear G4 so as to connect the engine 10 to the output shaft 4; and then, the engine 10 restores the output torque, and drives the output shaft 4 through the input shaft 3, the first synchronizer S1, the first gear G1/fourth gear G4 and the second synchronizer S2 (engaging the fourth gear G4). The system enters the HEV parallel hybrid mode.

Example 2: When in the series hybrid mode, the engine 10 is connected to the second motor 2 through the input shaft 3, the first synchronizer S1 (engaging the first gear G1), the first gear G1/fourth gear G4/tenth gear G10 and the second intermediate shaft 6 to drive the second motor 2 to generate power, and the first motor 1 drives the output shaft 4 through the first intermediate shaft 5, the seventh gear G7/fifth gear G5 or the eighth gear G8/sixth gear G6 and the third synchronizer S3. When switching from the series hybrid mode to the parallel hybrid mode, the engine 10 and the second motor 2 unload, the first motor 1 drives the output shaft 4, and the first synchronizer S1 disengages the first gear G1. In this case, there are two methods to adjust the speed and shift gears: Method 1: The engine 10 adjusts the speed, and when the first synchronizer S1 is synchronous with the second gear G2, the first synchronizer engages the second gear G2. Method 2: the second motor 2 adjusts the speed, and when the output shaft 4 is synchronous with the third gear G3 (or the fourth gear G4), the second synchronizer S2 engages, the second motor 2 drives, the first motor 1 unloads, and the third synchronizer S3 disengages. The first motor 1 adjusts the speed, and when the input shaft 3 is synchronous with the second gear G2, the first synchronizer S1 engages the second gear G2. The first motor 1 adjusts the speed, and when the output shaft 4 is synchronous with the fifth gear G5 (or the sixth gear G6), the third synchronizer S3 engages. After speed adjustment and gear shifting are completed, the engine 10 drives the output shaft 4 through the input shaft 3, the first synchronizer S1, the second gear G2/fifth gear G5 and the third synchronizer S3 (engaging the fifth gear G5). The system enters the HEV parallel hybrid mode.

This embodiment can realize gear shifting without power interruption in the HEV mode. The specific working principles are as follows:

Engine 10 and motor parallel hybrid: Example 1: the first synchronizer S1 engages the first gear G1, the second synchronizer S2 engages the fourth gear G4, the engine 10 drives the output shaft 4 through the input shaft 3, the first synchronizer S1, the first gear G1/fourth gear G4 and the second synchronizer S2, the second motor 2 drives the output shaft 4 through the second intermediate shaft 6, the tenth gear G10/fourth gear G4 and the second synchronizer S2, and the first motor 1 may drive the output shaft 4 through the first intermediate shaft 5, the seventh gear G7/fifth gear G5 or the eighth gear G8/sixth gear G6 and the third synchronizer S3 (engaging the fifth gear G5 or the sixth gear G6). At this time, to shift from the fourth gear G4 to the third gear G3, the operation is as follows: the engine 10 and the second motor 2 unload, the first motor 1 drives the output shaft 4 and compensates for the torques of the engine 10 and the second motor 2, and the second synchronizer S2 disengages the fourth gear G4; and the second motor 2 adjusts the speed, and when the third gear G3 is synchronous with the output shaft 4, the second synchronizer S2 engages the third gear G3, the first motor 1 reduces the torque, and the engine 10 and the second motor 2 restore the torques to drive the output shaft 4, thereby completing gear shifting without power interruption. At this time, to shift from the fourth gear G4 to the fifth gear G5 or the sixth gear G6, the operation is as follows: the engine 10 and the second motor 2 unload, the first motor 1 drives the output shaft 4 and compensate for the torques of the engine 10 and the second motor 2, and the first synchronizer S1 disengages the first gear G1. At this time, there are two methods to adjust the speed and shift gears: Method 1: The engine 10 adjusts the speed, and when the second gear G2 is synchronous with the input shaft 3, the first synchronizer S1 engages the second gear G2. Method 2: the first motor 1 unloads, the second motor 2 outputs the torque to drive the output shaft 4 instead of the first motor 1, and the third synchronizer S3 disengages; the first motor 1 adjusts the speed, and when the second gear G2 is synchronous with the input shaft 3, the first synchronizer S1 engages the second gear G2; and the first motor 1 adjusts the speed, and when the fifth gear G5 (or the sixth gear G6) is synchronous with the output shaft 4, the third synchronizer S3 engages the fifth gear G5 (or the sixth gear G6). After speed adjustment and gear shifting are completed, the first motor 1 reduces the torque, and the engine 10 and the second motor 2 restore the torques to drive the output shaft 4, thereby completing gear shifting without power interruption. The operations for the other two positions are similar.

In this embodiment, the positions may be set as follows:

| | | | | First | Second | Third |
|---|---|---|---|---|---|---|
| | Engine | | | synchronizer | synchronizer | synchronizer |
| | 10 | First motor 1 | Second motor 2 | S1 | S2 | S3 |
| EV 1st position | Off | Drive/regenerative brake | Off | Neutral | Neutral | Left |
| EV 2nd position | Off | Drive/regenerative brake | Off | Neutral | Neutral | Right |
| EV 3rd position | Off | Off | Drive/regenerative brake | Neutral | Left | Neutral |
| EV 4th position | Off | Off | Drive/regenerative brake | Neutral | Right | Neutral |
| Parallel hybrid | On | Drive/regenerative brake | Off | Right | Neutral | Left |
| 1st position | | | | | | |
| Parallel hybrid | On | Drive/regenerative brake | Off | Right | Neutral | Right |
| 2nd position | | | | | | |
| Parallel hybrid | On | Off | Drive/regenerative brake | Left | Right | Neutral |
| 3rd position | | | | | | |
| Parallel hybrid | On | Off | Drive/regenerative brake | Left | Left | Neutral |
| 4th position | | | | | | |
| Series hybrid | On | Start engine/generate | Drive/regenerative brake | Right | Left | Neutral |
| 1st position | | power | | | | |
| Series hybrid | On | Start engine/generate | Drive/regenerative brake | Right | Right | Neutral |
| 2nd position | | power | | | | |
| Series hybrid | On | Drive/regenerative brake | Start engine/generate | Left | Neutral | Left |
| 3rd position | | | power | | | |
| Series hybrid | On | Drive/regenerative brake | Start engine/generate | Left | Neutral | Right |
| 4th position | | | power | | | |

Note:
The positions are shown in an example of single motor drive, and the positions are not affected in the case of double motor drive.

Modes: EV: 4 positions for single motor drive; and 4 combinations for double motor drive: in the table, the EV 1st position is combined with the EV 3rd or 4th position, and the EV 2nd position is combined with the EV 3rd or 4th position. There are a total of 8 modes.

Parallel hybrid: 4 positions for single motor parallel hybrid; and 8 combinations for double motor parallel hybrid: in the table, the parallel hybrid 1st position is combined with the EV 3rd or 4th position, the parallel hybrid 2nd position is combined with the EV 3rd or 4th position, the parallel hybrid 3rd position is combined with the EV 1st or 2nd position, and the parallel hybrid 4th position is combined with the EV 1st or 2nd position. There are a total of 12 modes.

Series hybrid: 4 positions for series hybrid, which correspond to 4 modes.

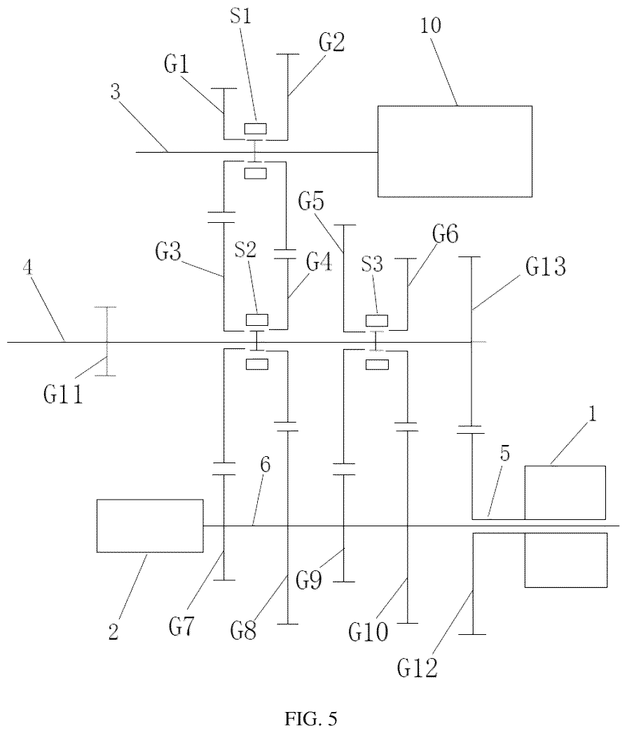

Embodiment V: As shown in FIG. 5, a multi-position variable speed transmission system for a hybrid electric vehicle, with reference to the description of Embodiment I, is different from Embodiment I in that: the first intermediate shaft 5 is connected with one first transmission gear which is a twelfth gear G12, the output shaft 4 is further connected with a third transmission gear which is a thirteenth gear G13, and the twelfth gear G12 meshes with the thirteenth gear 13. In this way, the first motor 1 can directly drive the output shaft 4.

The second intermediate shaft 6 is connected with four second transmission gears which are a seventh gear G7, an eighth gear G8, a ninth gear G9 and a tenth gear G10 respectively, the seventh gear G7 meshes with the third gear G3, the eighth gear G8 meshes with the fourth gear G4, the ninth gear G9 meshes with the fifth gear G5, and the tenth gear G10 meshes with the sixth gear G6.

With reference to the detailed description of the above embodiments and FIG. 5, those skilled in the art can understand the specific working process of this embodiment, and details will not be repeated here.

In this embodiment, the positions may be set as follows:

| | | | | First | Second | Third |
|---|---|---|---|---|---|---|
| | Engine | | | synchronizer | synchronizer | synchronizer |
| | 10 | First motor 1 | Second motor 2 | S1 | S2 | S3 |
| EV 1st position | Off | Drive/regenerative brake | Off | Neutral | Neutral | Neutral |
| EV 2nd position | Off | Off | Drive/regenerative brake | Neutral | Left | Neutral |
| EV 3rd position | Off | Off | Drive/regenerative brake | Neutral | Right | Neutral |
| EV 4th position | Off | Off | Drive/regenerative brake | Neutral | Neutral | Left |
| EV 5th position | Off | Off | Drive/regenerative brake | Neutral | Neutral | Right |
| Parallel hybrid | On | Off | Drive/regenerative brake | Left | Right | Neutral |
| 1st position | | | | | | |
| Parallel hybrid | On | Off | Drive/regenerative brake | Left | Left | Neutral |
| 2nd position | | | | | | |
| Parallel hybrid | On | Off | Drive/regenerative brake | Left | Neutral | Left |
| 3rd position | | | | | | |
| Parallel hybrid | On | Off | Drive/regenerative brake | Left | Neutral | Right |
| 4th position | | | | | | |
| Parallel hybrid | On | Off | Drive/regenerative brake | Right | Right | Neutral |
| 5th position | | | | | | |
| Parallel hybrid | On | Off | Drive/regenerative brake | Right | Left | Neutral |
| 6th position | | | | | | |
| Parallel hybrid | On | Off | Drive/regenerative brake | Right | Neutral | Left |
| 7th position | | | | | | |
| Parallel hybrid | On | Off | Drive/regenerative brake | Right | Neutral | Right |
| 8th position | | | | | | |
| Series hybrid | On | Drive/regenerative brake | Start engine/generate | Right or | Neutral | Neutral |
| 1st position | | | power | left | | |

Note:
The positions are shown in an example of single motor drive, and the positions are not affected in the case of double motor drive.

Modes: EV: 5 positions for single motor drive; and 4 combinations for double motor drive: the EV 1st position is respectively combined with the EV 2nd, 3rd, 4th and 5th positions. There are a total of 9 modes.

Parallel hybrid: 8 positions for single motor parallel hybrid; and 8 combinations for double motor parallel hybrid: in the table, each position in parallel hybrid is respectively combined with the EV 1st position. There are a total of 16 modes.

Series hybrid: 1 position for series hybrid, which corresponds to 2 modes depending on whether the first synchronizer S1 engages the gear on the left side or the gear on the right side.

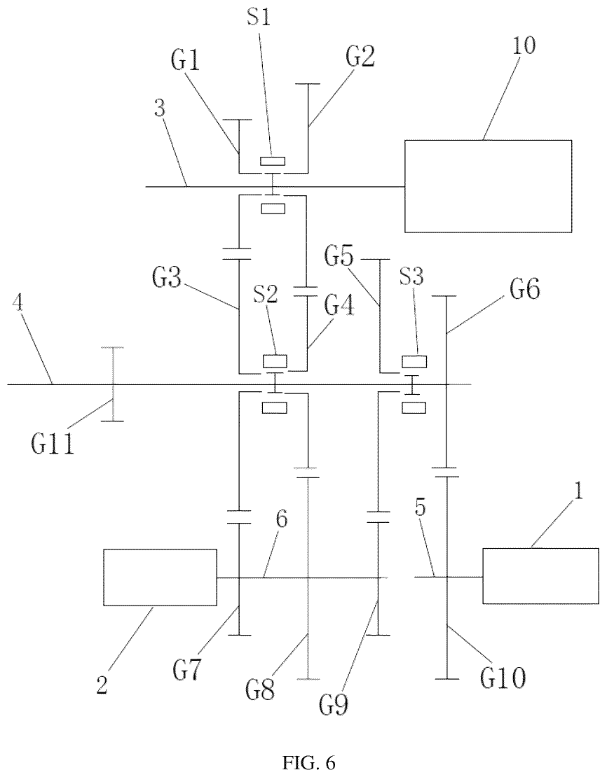

Embodiment VI: As shown in FIG. 6, a multi-position variable speed transmission system for a hybrid electric vehicle, with reference to the description of Embodiment I, is different from Embodiment I in that: the sixth gear G6 is not sleeved on the output shaft 4 but directly connected to the output shaft 4, the sixth gear G6 becomes the third transmission gear, and the third synchronizer S3 only connects or disconnects the fifth gear G5 with the output shaft 4. The first intermediate shaft 5 is connected with one first transmission gear which is a tenth gear G10, and the tenth gear G10 meshes with the sixth gear G6. In this way, the first motor 1 can directly drive the output shaft 4.

The second intermediate shaft 6 is connected with three second transmission gears which are a seventh gear G7, an eighth gear G8 and a ninth gear G9 respectively, the seventh gear G7 meshes with the third gear G3, the eighth gear G8 meshes with the fourth gear G4, and the ninth gear G9 meshes with the fifth gear G5.

With reference to the detailed description of the above embodiments and FIG. 6, those skilled in the art can understand the specific working process of this embodiment, and details will not be repeated here.

In this embodiment, the positions may be set as follows:

| | | | | First | Second | Third |
|---|---|---|---|---|---|---|
| | Engine | | | synchronizer | synchronizer | synchronizer |
| | 10 | First motor 1 | Second motor 2 | S1 | S2 | S3 |
| EV 1st position | Off | Drive/regenerative brake | Off | Neutral | Neutral | Neutral |
| EV 2nd position | Off | Off | Drive/regenerative brake | Neutral | Left | Neutral |
| EV 3rd position | Off | Off | Drive/regenerative brake | Neutral | Right | Neutral |
| EV 4th position | Off | Off | Drive/regenerative brake | Neutral | Neutral | Left |
| Parallel hybrid | On | Off | Drive/regenerative brake | Left | Right | Neutral |
| 1st position | | | | | | |
| Parallel hybrid | On | Off | Drive/regenerative brake | Left | Left | Neutral |
| 2nd position | | | | | | |
| Parallel hybrid | On | Off | Drive/regenerative brake | Left | Neutral | Left |
| 3rd position | | | | | | |
| Parallel hybrid | On | Off | Drive/regenerative brake | Right | Right | Neutral |
| 4th position | | | | | | |
| Parallel hybrid | On | Off | Drive/regenerative brake | Right | Left | Neutral |
| 5th position | | | | | | |
| Parallel hybrid | On | Off | Drive/regenerative brake | Right | Neutral | Left |
| 6th position | | | | | | |
| Series hybrid | On | Drive/regenerative brake | Start engine/generate | Right or | Neutral | Neutral |
| 1st position | | | power | left | | |

Note:
The positions are shown in an example of single motor drive, and the positions are not affected in the case of double motor drive.

Modes: EV: 4 positions for single motor drive; and 3 combinations for double motor drive: the EV 1st position is respectively combined with the EV 2nd, 3rd and 4th positions. There are a total of 7 modes.

Parallel hybrid: 6 positions for single motor parallel hybrid; and 6 combinations for double motor parallel hybrid: in the table, each position in parallel hybrid is respectively combined with the EV 1st position. There are a total of 12 modes.

Series hybrid: 1 position for series hybrid, which corresponds to 2 modes depending on whether the first synchronizer S1 engages the gear on the left side or the gear on the right side.

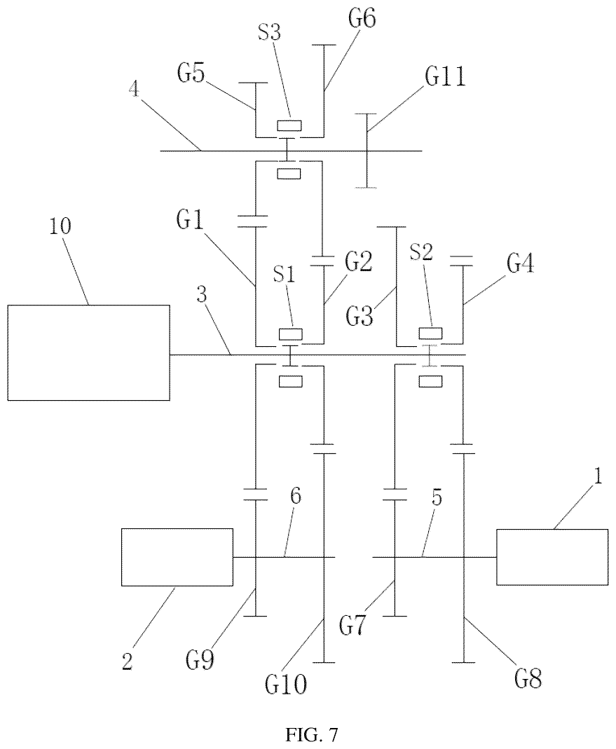

Embodiment VII: As shown in FIG. 7, a multi-position variable speed transmission system for a hybrid electric vehicle includes an engine 10, a first motor 1, a second motor 2, an input shaft 3, an output shaft 4, a first intermediate shaft 5, a second intermediate shaft 6, a first synchronizer S1, a second synchronizer S2 and a third synchronizer S3. The input shaft 3 is connected to the engine 10. The first intermediate shaft 5 is connected to the first motor 1. The second intermediate shaft 6 is connected to the second motor 2. A drive shaft of the first motor 1 may be connected to the first intermediate shaft 5 or integrated with the first intermediate shaft 5 through a coupling. A drive shaft of the second motor 2 may be connected to the second intermediate shaft 6 or integrated with the second intermediate shaft 6 through a coupling.

Both the first synchronizer S1 and the second synchronizer S2 are connected to the input shaft 3, a first gear G1, a second gear G2, a third gear G3 and a fourth gear G4 are sleeved on the input shaft 3, the input shaft 3 is connected or disconnected with the first gear G1 or the second gear G2 respectively through the first synchronizer S1, and the input shaft 3 is connected or disconnected with the third gear G3 or the fourth gear G4 respectively through the second synchronizer S2.

The third synchronizer S3 is connected to the output shaft 4, a fifth gear G5 and a sixth gear G6 are sleeved on the output shaft 4, the output shaft 4 is connected or disconnected with the fifth gear G5 or the sixth gear G6 respectively through the third synchronizer S3.

The first intermediate shaft 5 is connected with two first transmission gears which are a seventh gear G7 and an eighth gear G8 respectively, the seventh gear G7 meshes with the third gear G3, and the eighth gear G8 meshes with the fourth gear G4.

The second intermediate shaft 6 is connected with two second transmission gears which are a ninth gear G9 and a tenth gear G10 respectively, the ninth gear G9 meshes with the first gear G1, and the tenth gear G10 meshes with the second gear G2. The first gear G1 meshes with the fifth gear G5, and the second gear G2 meshes with the sixth gear G6. The output shaft 4 is further connected with an output gear G11.

With reference to the detailed description of the above embodiments and FIG. 7, those skilled in the art can understand the specific working process of this embodiment, and details will not be repeated here.

In this embodiment, the positions may be set as follows:

| | | | | First | Second | Third |
|---|---|---|---|---|---|---|
| | Engine | | | synchronizer | synchronizer | synchronizer |
| | 10 | First motor 1 | Second motor 2 | S1 | S2 | S3 |
| EV 1st position | Off | Off | Drive/regenerative brake | Left | Neutral | Neutral |
| EV 2nd position | Off | Off | Drive/regenerative brake | Right | Neutral | Neutral |
| Parallel hybrid | On | Off | Drive/regenerative brake | Left | Left | Neutral |
| 1st position | | | | | | |
| Parallel hybrid | On | Off | Drive/regenerative brake | Left | Right | Neutral |
| 2nd position | | | | | | |
| Parallel hybrid | On | Off | Drive/regenerative brake | Right | Right | Neutral |
| 3rd position | | | | | | |
| Parallel hybrid | On | Off | Drive/regenerative brake | Right | Left | Neutral |
| 4th position | | | | | | |
| Series hybrid | On | Drive/regenerative brake | Start engine/generate | Left or | Neutral | Left |
| 1st position | | | power | right | | |
| Series hybrid | On | Drive/regenerative brake | Start engine/generate | Left or | Neutral | Right |
| 2nd position | | | power | right | | |

Note:
The positions are shown in an example of single motor drive, and the positions are not affected in the case of double motor drive.

Modes: EV: 2 positions for single motor drive.

Parallel hybrid: 4 positions for single motor parallel hybrid; and 8 combinations for double motor parallel hybrid: in the table, each position in parallel hybrid is combined with the first motor 1 depending on whether the third synchronizer S3 engages the gear on the left side or the gear on the right side. There are a total of 12 modes.

Series hybrid: 2 positions for series hybrid, which correspond to 4 modes depending on whether the third synchronizer S3 engages the gear on the left side or the gear on the right side.

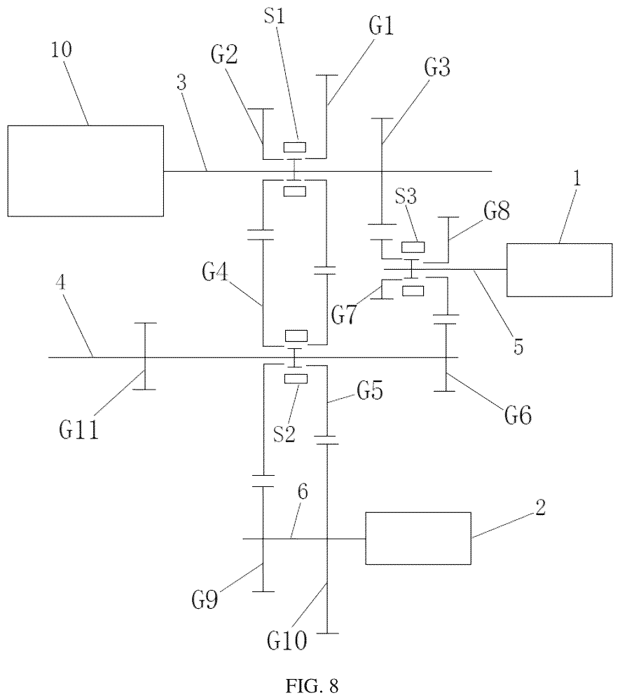

Embodiment VIII: As shown in FIG. 8, a multi-position variable speed transmission system for a hybrid electric vehicle includes an engine 10, a first motor 1, a second motor 2, an input shaft 3, an output shaft 4, a first intermediate shaft 5, a second intermediate shaft 6, a first synchronizer S1, a second synchronizer S2 and a third synchronizer S3. The input shaft 3 is connected to the engine 10. The first intermediate shaft 5 is connected to the first motor 1. The second intermediate shaft 6 is connected to the second motor 2. A drive shaft of the first motor 1 may be connected to the first intermediate shaft 5 or integrated with the first intermediate shaft 5 through a coupling. A drive shaft of the second motor 2 may be connected to the second intermediate shaft 6 or integrated with the second intermediate shaft 6 through a coupling. The first intermediate shaft 5 and the second intermediate shaft 6 are parallel to the input shaft 3 and the output shaft 4.

The first synchronizer S1 is connected to the input shaft 3, a first gear G1 and a second gear G2 are sleeved on the input shaft 3, the input shaft 3 is connected or disconnected with the first gear G1 or the second gear G2 respectively through the first synchronizer S1, and the input shaft 3 is further connected with a third gear G3.

The second synchronizer S2 is connected to the output shaft 4, a fourth gear G4 and a fifth gear G5 are sleeved on the output shaft 4, the output shaft 4 is connected or disconnected with the fourth gear G4 or the fifth gear G5 respectively through the second synchronizer S2, and the output shaft 4 is further connected with a sixth gear G6.

The third synchronizer S3 is connected to the first intermediate shaft 5, a seventh gear G7 and an eighth gear G8 are sleeved on the first intermediate shaft 5, and the first intermediate shaft 5 is connected or disconnected with the seventh gear G7 or the eighth gear G8 respectively through the third synchronizer S3.

The second intermediate shaft 6 is connected with a ninth gear G9 and a tenth gear G10, the ninth gear G9 meshes with the fourth gear G4, the tenth gear G10 meshes with the fifth gear G5, the first gear G1 meshes with the fifth gear G5, and the second gear G2 meshes with the fourth gear G4. The third gear G3 meshes with the seventh gear G7, and the sixth gear G6 meshes with the eighth gear G8. The first intermediate shaft 5 is further connected with an output gear G11.

With reference to the detailed description of the above embodiments and FIG. 8, those skilled in the art can understand the specific working process of this embodiment, and details will not be repeated here.

In this embodiment, the positions may be set as follows:

| | | | | First | Second | Third |
|---|---|---|---|---|---|---|
| | Engine | | | synchronizer | synchronizer | synchronizer |
| | 10 | First motor 1 | Second motor 2 | S1 | S2 | S3 |
| EV 1st position | Off | Off | Drive/regenerative brake | Neutral | Left | Neutral |
| EV 2nd position | Off | Off | Drive/regenerative brake | Neutral | Right | Neutral |
| EV 3rd position | Off | Drive/regenerative brake | Off | Neutral | Neutral | Right |
| Parallel hybrid | On | Off | Drive/regenerative brake | Left | Left | Neutral |
| 1st position | | | | | | |
| Parallel hybrid | On | Off | Drive/regenerative brake | Left | Right | Neutral |
| 2nd position | | | | | | |
| Parallel hybrid | On | Off | Drive/regenerative brake | Right | Right | Neutral |
| 3rd position | | | | | | |
| Parallel hybrid | On | Off | Drive/regenerative brake | Right | Left | Neutral |
| 4th position | | | | | | |
| Series hybrid | On | Drive/regenerative brake | Start engine/generate | Left or | Neutral | Right |
| 1st position | | | power | right | | |
| Series hybrid | On | Start engine/generate | Drive/regenerative brake | Neutral | Left | Left |
| 2nd position | | power | | | | |
| Series hybrid | On | Start engine/generate | Drive/regenerative brake | Neutral | Right | Left |
| 3rd position | | power | | | | |

Note:
The positions are shown in an example of single motor drive, and the positions are not affected in the case of double motor drive.

Modes: EV: 3 positions for single motor drive; and 2 combinations for double motor drive: the EV 1st position is combined with the EV 3rd position, and the EV 2nd position is combined with the EV 3rd position. There are a total of 5 modes.

Parallel hybrid: 4 positions for single motor parallel hybrid; and 8 combinations for double motor parallel hybrid: in the table, the parallel hybrid 1st, 2nd, 3rd and 4th positions are respectively combined with the third synchronizer S3 engaging the gear on the right side, and the parallel hybrid 1st, 2nd, 3rd and 4th positions are respectively combined with the third synchronizer S3 engaging the gear on the left side. There are a total of 12 modes.

Series hybrid: 3 positions for series hybrid, which correspond to 4 modes depending on whether the first synchronizer S1 engages the gear on the left side or the gear on the right side when the third synchronizer S3 engages the gear on the right side and whether the second synchronizer S2 engages the gear on the left side or the gear on the right side when the third synchronizer S3 engages the gear on the left side.

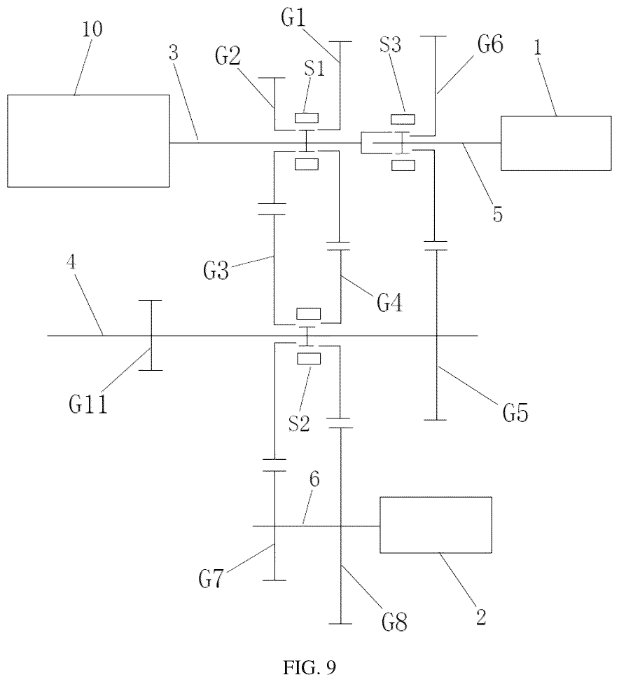

Embodiment IX: As shown in FIG. 9, a multi-position variable speed transmission system for a hybrid electric vehicle includes an engine 10, a first motor 1, a second motor 2, an input shaft 3, an output shaft 4, a first intermediate shaft 5, a second intermediate shaft 6, a first synchronizer S1, a second synchronizer S2 and a third synchronizer S3. The input shaft 3 is connected to the engine 10. The first intermediate shaft 5 is connected to the first motor 1. The second intermediate shaft 6 is connected to the second motor 2. A drive shaft of the first motor 1 may be connected to the first intermediate shaft 5 or integrated with the first intermediate shaft 5 through a coupling. A drive shaft of the second motor 2 may be connected to the second intermediate shaft 6 or integrated with the second intermediate shaft 6 through a coupling. The first intermediate shaft 5 and the second intermediate shaft 6 are parallel to the input shaft 3 and the output shaft 4.

The first synchronizer S1 is connected to the input shaft 3, a first gear G1 and a second gear G2 are sleeved on the input shaft 3, and the input shaft 3 is connected or disconnected with the first gear G1 or the second gear G2 respectively through the first synchronizer S1.

The second synchronizer S2 is connected to the output shaft 4, a third gear G3 and a fourth gear G4 are sleeved on the output shaft 4, the output shaft 4 is connected or disconnected with the third gear G3 or the fourth gear G4 respectively through the second synchronizer S2, and the output shaft 4 is further connected with a fifth gear G5.

The third synchronizer S3 is connected to the first intermediate shaft 5 and corresponds to one end of the input shaft 3, a sixth gear G6 is sleeved on the first intermediate shaft 5, the first intermediate shaft 5 is connected or disconnected with the sixth gear G6 through the third synchronizer S3, and the first intermediate shaft 5 is further connected or disconnected with the input shaft 3 through the third synchronizer S3.

The second intermediate shaft 6 is connected with a seventh gear G7 and an eighth gear G8, the seventh gear G7 meshes with the third gear G3, and the eighth gear G8 meshes with the fourth gear G4. The first gear G1 meshes with the fourth gear G4, the second gear G2 meshes with the third gear G3, and the fifth gear G5 meshes with the sixth gear G6. The output shaft 4 is further connected with an output gear G11.

With reference to the detailed description of the above embodiments and FIG. 8, those skilled in the art can understand the specific working process of this embodiment, and details will not be repeated here. The positions of this embodiment are set in the same way as Embodiment IX.

Although the invention has been specifically shown and described in connection with the preferred embodiments, it should be understood by those skilled in the art that various changes in form and details can be made without departing from the spirit and scope of the invention as defined by the appended claims, and shall all fall within the protection scope of the invention.

1. A multi-position variable speed transmission system for a hybrid electric vehicle, comprising an engine, a first motor, a second motor, an input shaft and an output shaft, wherein the input shaft is connected to the engine; the multi-position variable speed transmission system further comprises a first intermediate shaft, a second intermediate shaft, a first synchronizer, a second synchronizer and a third synchronizer; the first intermediate shaft is connected to the first motor, and the second intermediate shaft is connected to the second motor;
the first synchronizer is connected to the input shaft, a first gear and a second gear are sleeved on the input shaft, and the input shaft is connected or disconnected with the first gear or the second gear respectively through the first synchronizer;
both the second synchronizer and the third synchronizer are connected to the output shaft, a third gear, a fourth gear, a fifth gear and a sixth gear are sleeved on the output shaft, the output shaft is connected or disconnected with the third gear or the fourth gear respectively through the second synchronizer, and the output shaft is connected or disconnected with the fifth gear or the sixth gear respectively through the third synchronizer;
the first intermediate shaft is connected with at least one first transmission gear which selectively meshes with one of the third gear, the fourth gear, the fifth gear or the sixth gear sleeved on the output shaft, or the output shaft is further connected with a third transmission gear, and the at least one first transmission gear meshes with the third transmission gear;
the second intermediate shaft is connected with a plurality of second transmission gears, and each of the plurality of second transmission gears connected with the second intermediate shaft selectively meshes with one of the third gear, the fourth gear, the fifth gear or the sixth gear sleeved on the output shaft; and
at least one of:
the first gear or the second gear respectively meshes with one of the third gear, the fourth gear, the fifth gear or the sixth gear sleeved on the output shaft, or
the first gear or the second gear respectively meshes with one of the plurality of second transmission gears on the second intermediate shaft.

2. The multi-position variable speed transmission system for a hybrid electric vehicle according to claim 1, wherein the at least one first transmission gear is two first transmission gears which are a seventh gear and an eighth gear respectively, the seventh gear meshes with the fifth gear, and the eighth gear meshes with the sixth gear;
the plurality of second transmission gears are two second transmission gears which are a ninth gear and a tenth gear respectively, the ninth gear meshes with the third gear, and the tenth gear meshes with the fourth gear; and
the first gear meshes with the third gear, and the second gear meshes with the fourth gear.

3. The multi-position variable speed transmission system for a hybrid electric vehicle according to claim 2, wherein the third gear is formed by connecting a third large gear and a third small gear, an outer diameter of the third large gear is greater than an outer diameter of the third small gear, the third large gear meshes with the first gear, and the third small gear meshes with the ninth gear.

4. The multi-position variable speed transmission system for a hybrid electric vehicle according to claim 1, wherein the at least one first transmission gear is two first transmission gears which are a seventh gear and an eighth gear respectively, the seventh gear meshes with the fifth gear, and the eighth gear meshes with the sixth gear;
the plurality of second transmission gears are two second transmission gears which are a ninth gear and a tenth gear respectively, the ninth gear meshes with the third gear, and the tenth gear meshes with the fourth gear; and the first gear meshes with the ninth gear, and the second gear meshes with the tenth gear.

5. The multi-position variable speed transmission system for a hybrid electric vehicle according to claim 1, wherein the at least one first transmission gear is two first transmission gears which are a seventh gear and an eighth gear respectively, the seventh gear meshes with the fifth gear, and the eighth gear meshes with the sixth gear;
the plurality of second transmission gears are two second transmission gears which are a ninth gear and a tenth gear respectively, the ninth gear meshes with the third gear, and the tenth gear meshes with the fourth gear; and
the first gear meshes with the fourth gear, and the second gear meshes with the fifth gear.

6. The multi-position variable speed transmission system for a hybrid electric vehicle according to claim 1, wherein the at least one first transmission gear is one first transmission gear which is a twelfth gear, the output shaft is further connected with the third transmission gear which is a thirteenth gear, and the twelfth gear meshes with the thirteenth gear;
the plurality of second transmission gears are four second transmission gears which are a seventh gear, an eighth gear, a ninth gear and a tenth gear respectively, the seventh gear meshes with the third gear, the eighth gear meshes with the fourth gear, the ninth gear meshes with the fifth gear, and the tenth gear meshes with the sixth gear; and
the first gear meshes with the third gear, and the second gear meshes with the fourth gear.

7. The multi-position variable speed transmission system for a hybrid electric vehicle according to claim 1, wherein the sixth gear is directly connected to the output shaft, the sixth gear becomes the third transmission gear, and the third synchronizer only connects or disconnects the fifth gear with the output shaft; the at least one first transmission gear is one first transmission gear which is a tenth gear, and the tenth gear meshes with the sixth gear;
the plurality of second transmission gears are three second transmission gears which are a seventh gear, an eighth gear and a ninth gear respectively, the seventh gear meshes with the third gear, the eighth gear meshes with the fourth gear, and the ninth gear meshes with the fifth gear; and
the first gear meshes with the third gear, and the second gear meshes with the fourth gear.

8. The multi-position variable speed transmission system for a hybrid electric vehicle according to claim 1, wherein the first synchronizer, the second synchronizer and the third synchronizer are clutches.

9. The multi-position variable speed transmission system for a hybrid electric vehicle according to claim 1, wherein the multi-position variable speed transmission system has any one or more of the following operating modes:
electric vehicle mode in which at least one of the first motor or the second motor are involved in driving the output shaft;
series hybrid mode in which the engine is involved in driving the output shaft, or the engine and the first motor are involved in driving the output shaft, and the second motor is involved in power generation; and
parallel hybrid mode in which the engine is involved in driving the output shaft, the second motor is involved in synchronization during gear shifting, and the first motor is involved in driving the output shaft during the gear shifting.

10. A multi-position variable speed transmission system for a hybrid electric vehicle, comprising an engine, a first motor, a second motor, an input shaft and an output shaft, wherein the input shaft is connected to the engine; the multi-position variable speed transmission system further comprises a first intermediate shaft, a second intermediate shaft, a first synchronizer, a second synchronizer and a third synchronizer; the first intermediate shaft is connected to the first motor, and the second intermediate shaft is connected to the second motor;
both the first synchronizer and the second synchronizer are connected to the input shaft, a first gear, a second gear, a third gear and a fourth gear are sleeved on the input shaft, the input shaft is connected or disconnected with the first gear or the second gear respectively through the first synchronizer, and the input shaft is connected or disconnected with the third gear or the fourth gear respectively through the second synchronizer;
the third synchronizer is connected to the output shaft, a fifth gear and a sixth gear are sleeved on the output shaft, the output shaft is connected or disconnected with the fifth gear or the sixth gear respectively through the third synchronizer;
the first intermediate shaft is connected with two first transmission gears which are a seventh gear and an eighth gear respectively, the seventh gear meshes with the third gear, and the eighth gear meshes with the fourth gear;
the second intermediate shaft is connected with two second transmission gears which are a ninth gear and a tenth gear respectively, the ninth gear meshes with the first gear, and the tenth gear meshes with the second gear; and
the first gear meshes with the fifth gear, and the second gear meshes with the sixth gear.

11. A multi-position variable speed transmission system for a hybrid electric vehicle, comprising an engine, a first motor, a second motor, an input shaft and an output shaft, wherein the input shaft is connected to the engine; the multi-position variable speed transmission system further comprises a first intermediate shaft, a second intermediate shaft, a first synchronizer, a second synchronizer and a third synchronizer; the first intermediate shaft is connected to the first motor, and the second intermediate shaft is connected to the second motor;
the first synchronizer is connected to the input shaft, a first gear and a second gear are sleeved on the input shaft, the input shaft is connected or disconnected with the first gear or the second gear respectively through the first synchronizer, and the input shaft is further connected with a third gear;
the second synchronizer is connected to the output shaft, a fourth gear and a fifth gear are sleeved on the output shaft, the output shaft is connected or disconnected with the fourth gear or the fifth gear respectively through the second synchronizer, and the output shaft is further connected with a sixth gear;
the third synchronizer is connected to the first intermediate shaft, a seventh gear and an eighth gear are sleeved on the first intermediate shaft, and the first intermediate shaft is connected or disconnected with the seventh gear or the eighth gear respectively through the third synchronizer;
the second intermediate shaft is connected with a ninth gear and a tenth gear, the ninth gear meshes with the fourth gear, the tenth gear meshes with the fifth gear, the first gear meshes with the fifth gear, and the second gear meshes with the fourth gear; and
the third gear meshes with the seventh gear, and the sixth gear meshes with the eighth gear.

12. A multi-position variable speed transmission system for a hybrid electric vehicle, comprising an engine, a first motor, a second motor, an input shaft and an output shaft, wherein the input shaft is connected to the engine; the multi-position variable speed transmission system further comprises a first intermediate shaft, a second intermediate shaft, a first synchronizer, a second synchronizer and a third synchronizer; the first intermediate shaft is connected to the first motor, and the second intermediate shaft is connected to the second motor;
the first synchronizer is connected to the input shaft, a first gear and a second gear are sleeved on the input shaft, and the input shaft is connected or disconnected with the first gear or the second gear respectively through the first synchronizer;
the second synchronizer is connected to the output shaft, a third gear and a fourth gear are sleeved on the output shaft, the output shaft is connected or disconnected with the third gear or the fourth gear respectively through the second synchronizer, and the output shaft is further connected with a fifth gear;
the third synchronizer is connected to the first intermediate shaft and corresponds to one end of the input shaft, a sixth gear is sleeved on the first intermediate shaft, the first intermediate shaft is connected or disconnected with the sixth gear through the third synchronizer, and the first intermediate shaft is further connected or disconnected with the input shaft through the third synchronizer;
the second intermediate shaft is connected with a seventh gear and an eighth gear, the seventh gear meshes with the third gear, and the eighth gear meshes with the fourth gear; and the first gear meshes with the fourth gear, the second gear meshes with the third gear, and the fifth gear meshes with the sixth gear.

13. The multi-position variable speed transmission system for a hybrid electric vehicle according to claim 2, wherein the multi-position variable speed transmission system has any one or more of the following operating modes:
electric vehicle mode in which at least one of the first motor or the second motor are involved in driving the output shaft;
series hybrid mode in which the engine is involved in driving the output shaft, or the engine and the first motor are involved in driving the output shaft, and the second motor is involved in power generation; and
parallel hybrid mode in which the engine is involved in driving the output shaft, the second motor is involved in synchronization during gear shifting, and the first motor is involved in driving the output shaft during the gear shifting.

14. The multi-position variable speed transmission system for a hybrid electric vehicle according to claim 3, wherein the multi-position variable speed transmission system has any one or more of the following operating modes:
electric vehicle mode in which at least one of the first motor or the second motor are involved in driving the output shaft;
series hybrid mode in which the engine is involved in driving the output shaft, or the engine and the first motor are involved in driving the output shaft, and the second motor is involved in power generation; and
parallel hybrid mode in which the engine is involved in driving the output shaft, the second motor is involved in synchronization during gear shifting, and the first motor is involved in driving the output shaft during the gear shifting.

15. The multi-position variable speed transmission system for a hybrid electric vehicle according to claim 4, wherein the multi-position variable speed transmission system has any one or more of the following operating modes:
electric vehicle mode in which at least one of the first motor or the second motor are involved in driving the output shaft;
series hybrid mode in which the engine is involved in driving the output shaft, or the engine and the first motor are involved in driving the output shaft, and the second motor is involved in power generation; and
parallel hybrid mode in which the engine is involved in driving the output shaft, the second motor is involved in synchronization during gear shifting, and the first motor is involved in driving the output shaft during the gear shifting.

16. The multi-position variable speed transmission system for a hybrid electric vehicle according to claim 5, wherein the multi-position variable speed transmission system has any one or more of the following operating modes:
electric vehicle mode in which at least one of the first motor or the second motor are involved in driving the output shaft;
series hybrid mode in which the engine is involved in driving the output shaft, or the engine and the first motor are involved in driving the output shaft, and the second motor is involved in power generation; and
parallel hybrid mode in which the engine is involved in driving the output shaft, the second motor is involved in synchronization during gear shifting, and the first motor is involved in driving the output shaft during the gear shifting.

17. The multi-position variable speed transmission system for a hybrid electric vehicle according to claim 6, wherein the multi-position variable speed transmission system has any one or more of the following operating modes:
electric vehicle mode in which at least one of the first motor or the second motor are involved in driving the output shaft;
series hybrid mode in which the engine is involved in driving the output shaft, or the engine and the first motor are involved in driving the output shaft, and the second motor is involved in power generation; and
parallel hybrid mode in which the engine is involved in driving the output shaft, the second motor is involved in synchronization during gear shifting, and the first motor is involved in driving the output shaft during the gear shifting.

18. The multi-position variable speed transmission system for a hybrid electric vehicle according to claim 7, wherein the multi-position variable speed transmission system has any one or more of the following operating modes:
electric vehicle mode in which at least one of the first motor or the second motor are involved in driving the output shaft;
series hybrid mode in which the engine is involved in driving the output shaft, or the engine and the first motor are involved in driving the output shaft, and the second motor is involved in power generation; and
parallel hybrid mode in which the engine is involved in driving the output shaft, the second motor is involved in synchronization during gear shifting, and the first motor is involved in driving the output shaft during the gear shifting.
